(19) United States
(12) Patent Application Publication
(10) Pub. No.: US 2021/0209947 A1
(43) Pub. Date: Jul. 8, 2021

(54) TRAFFIC LANE POSITION INFORMATION OUTPUT DEVICE

(71) Applicant: DENSO CORPORATION, Kariya-city (JP)

(72) Inventor: Tomoo NOMURA, Kariya-city (JP)

(21) Appl. No.: 17/211,275

(22) Filed: Mar. 24, 2021

Related U.S. Application Data
(63) Continuation of application No. PCT/JP2019/044704, filed on Nov. 14, 2019.

(30) Foreign Application Priority Data
Nov. 27, 2018 (JP) 2018-221301

(51) Int. Cl. G08G 1/133; G06T 7/70; G06K 9/00

(52) U.S. Cl. CPC G08G 1/133; G06T 2207/30256; G06K 9/00798; G06T 7/70

(57) ABSTRACT

The traffic lane position information output device includes an imaging unit that images a periphery of a vehicle, a traffic lane extraction unit that extracts a traffic lane from an image captured by the imaging unit, and a traffic lane position information output unit that outputs traffic lane position information indicating a position of the traffic lane extracted by the traffic lane extraction unit. The traffic lane position information output unit outputs the traffic lane position information in a predetermined case where the traffic lane appears correctly in the image captured by the imaging unit.

### CROSS REFERENCE TO RELATED APPLICATION

The present application is a continuation application of International Patent Application No. PCT/JP2019/044704 filed on Nov. 14, 2019, which designated the U.S. and claims the benefit of priority from Japanese Patent Application No. 2018-221301 filed on Nov. 27, 2018. The entire disclosures of all of the above applications are incorporated herein by reference.

### TECHNICAL FIELD

The present disclosure relates to a traffic lane position information output device that outputs traffic lane position information for generating a traffic lane map representing a traveling lane of a vehicle.

### BACKGROUND

For example, in a conceivable technique, the periphery of the vehicle is imaged by an in-vehicle camera, traffic lane position information is generated from the obtained image, and a lane map representing the traveling lane of the vehicle is generated based on the generated traffic lane position information.

### SUMMARY

The traffic lane position information output device includes an imaging unit that images a periphery of a vehicle, a traffic lane extraction unit that extracts a traffic lane from an image captured by the imaging unit, and a traffic lane position information output unit that outputs traffic lane position information indicating a position of the traffic lane extracted by the traffic lane extraction unit. The traffic lane position information output unit outputs the traffic lane position information in a predetermined case where the traffic lane appears correctly in the image captured by the imaging unit.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram schematically showing a configuration example of a traffic lane position information output device, a center server, and a traffic lane map generation system according to the present embodiment;

FIG. 2 is a diagram schematically showing an example of an image captured by the imaging unit according to the present embodiment;

FIG. 3 is a diagram schematically showing an example of generating a traffic lane map according to the present embodiment;

FIG. 4 is a flowchart schematically showing an operation example of the traffic lane position information output device according to the present embodiment;

FIG. 5 is a diagram schematically showing an example of a situation in which the traffic lane position information according to the present embodiment cannot be accurately output;

FIG. 6 is a flowchart showing an example of a situation determination process based on image analysis information according to the present embodiment; and

FIG. 7 is a flowchart showing an example of a situation determination process based on vehicle information according to the present embodiment.

### DETAILED DESCRIPTION

For example, when a vehicle changes traffic lanes, the vehicle crosses the lane so that the lane is located directly under the vehicle. That is, the vehicle goes through a state of crossing the lane. Then, in such a state, there is a possibility that the reference position for specifying the lane position in the image and the lane located directly under the vehicle may overlap. In such a case, it may be difficult to accurately identify the position information of a plurality of lanes. And even if a lane map is generated based on such inaccurate lane position information, it may be difficult to generate an accurate lane map.

Therefore, we provide a traffic lane position information output device that can output traffic lane position information for generating a more accurate lane map.

In one aspect of the present embodiments, the traffic lane position information output device includes: an imaging unit that images the periphery of the vehicle; a traffic lane extraction unit that extracts traffic lanes from an image captured by the imaging unit; and a traffic lane position information output unit that outputs the traffic lane position information indicative of the position of the traffic lane extracted by the lane extraction unit. The traffic lane position information output unit outputs the traffic lane position information under a predetermined condition such that the traffic lane appears accurately in the image captured by the imaging unit.

According to this configuration, a more accurate lane map can be generated based on such a traffic lane position information since the traffic lane position information is output when the lane appears accurately in the image captured by the imaging unit. That is, according to the traffic lane position information output device according to the present disclosure, it is possible to output traffic lane position information for generating a more accurate lane map.

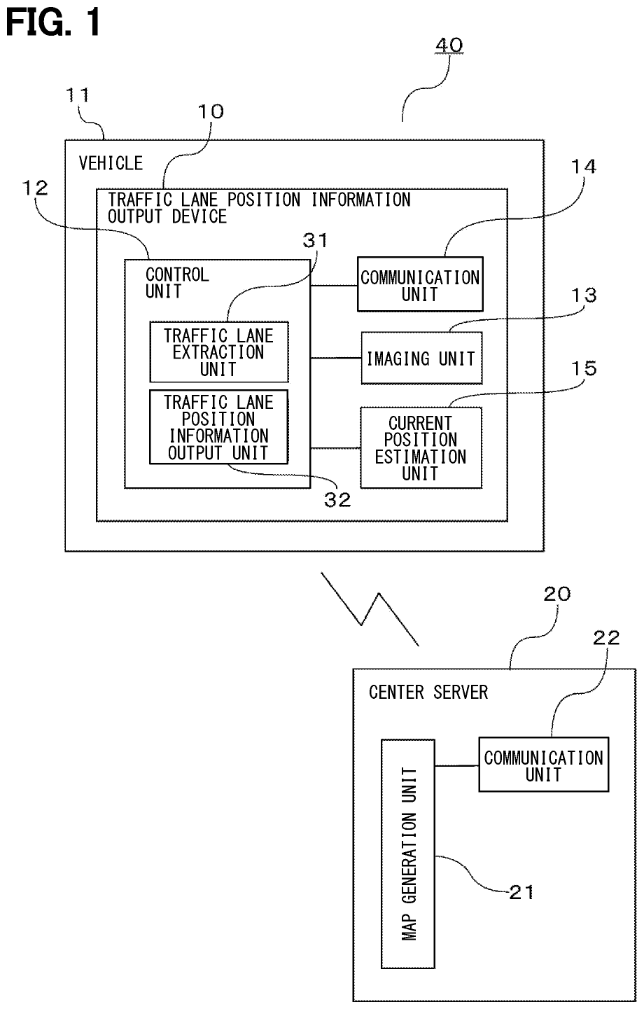

Hereinafter, an embodiment relating to the traffic lane position information output device will be described with reference to the drawings. The traffic lane position information output device 10 illustrated in FIG. 1 is mounted on a moving body such as a vehicle 11, and includes a control unit 12, an imaging unit 13, a communication unit 14, a current position estimation unit 15, and the like. The control unit 12 mainly includes, for example, a micro-computer or a memory, and controls the overall operation of the traffic lane position information output device 10 based on a control program. The imaging unit 13 includes, for example, an in-vehicle camera mounted on the vehicle 11, and is configured to be capable of imaging the periphery of the vehicle 11, in this case, at least the front scenery of the vehicle 11 in the traveling direction. The communication unit 14 includes a communication module including, for example, a communication antenna (not shown), and is configured to enable wireless communication with an external center server 20.

The current position estimation unit 15 includes, for example, a positioning antenna (not shown) such as a GPS antenna (GPS: Global Positioning System), an acceleration sensor, a vehicle speed sensor, and the like. The current position estimation unit 15 is configured to estimate a current position of the vehicle 11 based on various information such as a signal received from the positioning satellite via the positioning antenna, the acceleration of the vehicle 11 detected by the acceleration sensor, and the traveling speed of the vehicle 11 detected by the vehicle speed sensor. Further, the control unit 12 is configured to be able to add the current position information estimated by the current position estimation unit 15 to the image data obtained by the imaging unit 13. That is, the control unit 12 is configured to be able to add position information indicating the position where the image is captured to the image data obtained by the imaging unit 13.

Further, the control unit 12 virtually realizes the traffic lane extraction unit 31 and the traffic lane position information output unit 32 by software by executing the control program. The lane position information output device 10 may have various processing units such as a traffic lane extraction unit 31 and a traffic lane position information output unit 32 realized by hardware, or may be realized by a combination of software and hardware.

The lane extraction unit 31 extracts a “traffic lane” from the image by performing a well-known image analysis process on the image captured by the imaging unit 13. Specifically, the traffic lane position information output device 10 stores a plurality of types of lane pattern data representing lanes in advance, and the traffic lane extraction unit 31 extracts the “traffic lane” based on the image captured by the imaging unit 13 by comparing the image data obtained by the imaging unit 13 and a plurality of types of lane pattern data.

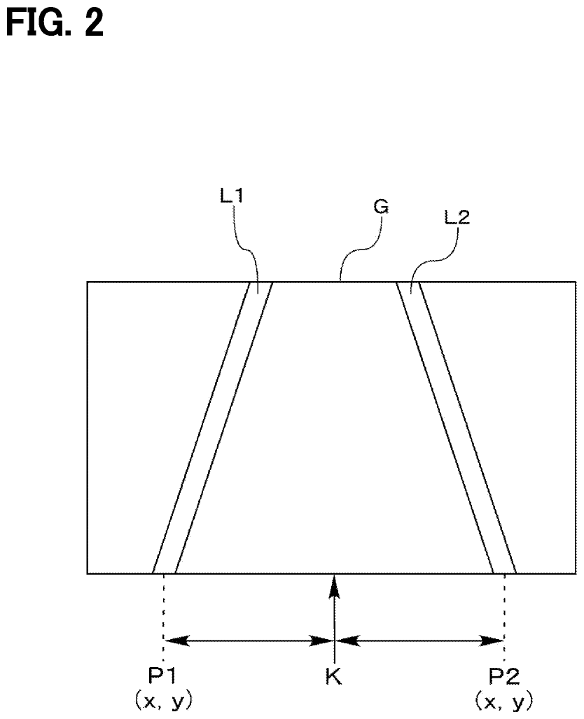

The traffic lane position information output unit 32 generates traffic lane position information indicating the position of the traffic lane extracted from the image by the traffic lane extraction unit 31. Specifically, as illustrated in FIG. 2, the traffic lane position information output unit 32 sets the reference position K in the image G obtained by the imaging unit 13. In this case, the traffic lane position information output unit 32 sets the center position of the image G obtained by the imaging unit 13 in the left-right direction as the reference position K.

Then, the traffic lane position information output unit 32 generates traffic lane position information indicating the position of the traffic lane extracted by the traffic lane extraction unit 31 with reference to the set reference position K as a standard position. In the image G illustrated in FIG. 2, there are a plurality of lanes such as two lanes L1 and L2 in this case. Therefore, the traffic lane position information output unit 32 generates traffic lane position information P1 and P2 for each of the plurality of lanes L1 and L2 with reference to the center position K.

As described above, the current position information estimated by the current position estimation unit 15, in other words, the position information indicating the position where the image is captured may be added to the image data obtained by the imaging unit 13. Therefore, by reflecting the current position information in the image data obtained by the imaging unit 13, the position coordinates of the reference position K, and further, the traffic lane position information P generated with reference to the reference position K are associated with the set coordinate system on the map data or the set coordinate system set on the actual road.

Then, the traffic lane position information output unit 32 outputs the generated traffic lane position information P. In this case, the traffic lane position information output unit 32 is configured to output the generated traffic lane position information P to the center server 20 via the communication unit 14. Further, the traffic lane position information output unit 32 generates and outputs the traffic lane position information P for each of the plurality of image data obtained by the imaging unit 13. Therefore, the center server 20 stores a plurality of lane position information P generated from a plurality of images obtained frequently by the imaging unit 13. Further, the traffic lane position information output unit 32 adds the current position information estimated by the current position estimation unit 15 to the traffic lane position information P to be output to the center server 20.

Next, a configuration example of the center server 20 will be described. As illustrated in FIG. 1, the center server 20 includes a map generation unit 21, a communication unit 22, and the like. The communication unit 22 includes, for example, a communication module including a communication antenna (not shown), and is configured to be able to communicate wirelessly with an external traffic lane position information output device 10. The center server 20 receives the traffic lane position information P output from the traffic lane position information output device 10 via the communication unit 22 and provides it to the map generation unit 21. The map generation unit 21 mainly includes, for example, a server computer, and generates a so-called lane map based on a plurality of lane position information P obtained from the traffic lane position information output device 10. The traffic lane map is a map showing the traveling lanes of vehicles provided on the road.

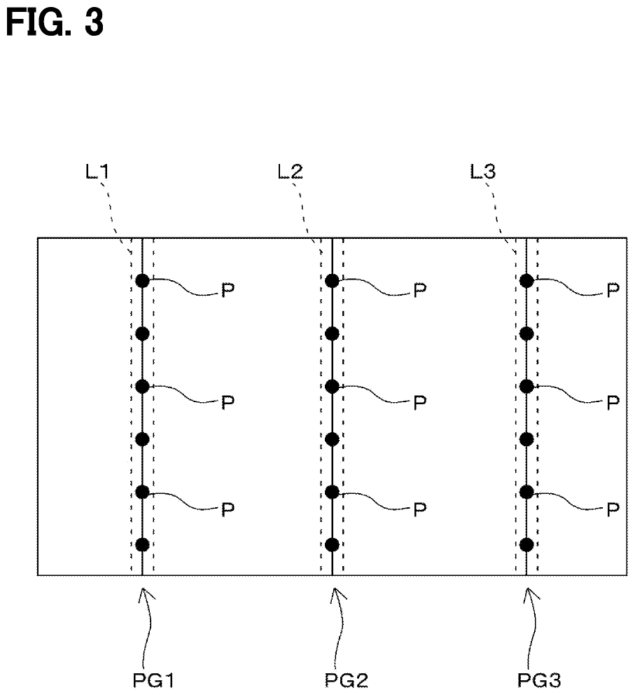

Here, an example of generating a traffic lane map will be described. As illustrated in FIG. 3, the center server 20 arranges a plurality of traffic lane position information P obtained from the traffic lane position information output device 10 based on the position information. Then, the center server 20 forms a traveling lane by synthesizing the plurality of traffic lane position information P. In the example shown in FIG. 3, a plurality of traveling lanes L1, L2, L3 having a plurality of linearly arranged, in this case, three lane position information groups PG1, PG2, PG3 are formed. Then, the center server 20 generates a lane map that reflects the formed traveling lane L on the road. Then, the center server 20 generates lane map data that reproduces the generated lane map.

The traffic lane position information output device 10 and the center server 20 provide a lane map generation system 40 that generates a lane map. Next, a part of the control example in the lane map generation system 40, that is, the control example in which the traffic lane position information P is output from the traffic lane position information output device 10 to the center server 20 will be described.

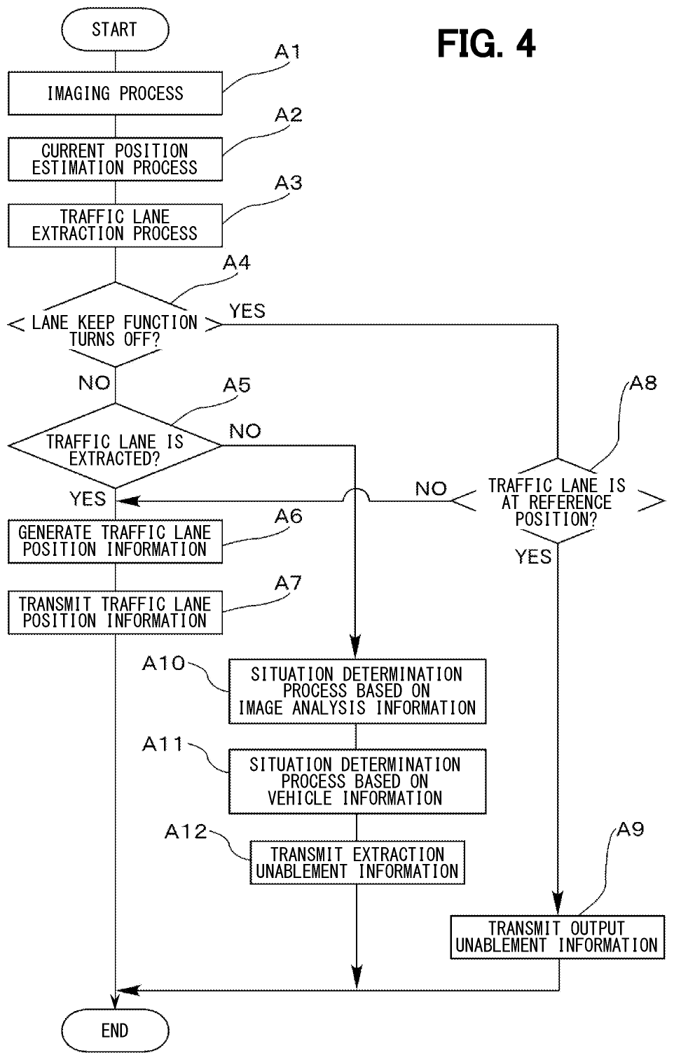

As illustrated in FIG. 4, when the control unit 12 of the traffic lane position information output device 10 executes the imaging process by the imaging unit 13 (at A1), the control unit 12 executes the current position estimation process by the current position estimation unit 15 (at A2) so that the current position information is added to the image data obtained by the imaging unit 13. Then, the control unit 12 executes a traffic lane extraction process for extracting a “lane” by performing a well-known image analysis process on the image data obtained by the imaging unit 13 (at A3).

When the control unit 12 completes the traffic lane extraction process from the image, it confirms whether or not the well-known lane keeping function provided in the vehicle 11 is turned off (at A4). The lane keeping function is a function of traveling the vehicle 11 along a traveling lane provided on the road, in other words, a function of traveling the vehicle 11 so as not to deviate from the traveling lane. The switching operation of the lane keeping function between the turn on and off may be, for example, configured to be switched according to the manual operation of the driver, or according to the automatic operation by the main control unit (not shown) that controls the overall operation of the vehicle 11 according to the traveling condition of the vehicle 11. Alternatively, it may be provided by a configuration that combines both operations.

When the lane keeping function is turned on (i.e., “NO” at A4), the control unit 12 confirms whether or not the “lane” has been extracted from the image in the traffic lane extraction process in step A3 (at A5). When the “lane” is extracted from the image (i.e., “YES” at A5), the control unit 12 generates the traffic lane position information P indicating the position of the traffic lane (at A6). Then, the control unit 12 transmits the generated traffic lane position information P to the center server 20 (at A7). At this time, the control unit 12 may attach the current position information obtained in step A2 to the traffic lane position information P to be transmitted to the center server 20.

Further, when the lane keeping function is turned off (i.e., “YES” at A4), the control unit 12 performs a well-known image analysis process on the image data obtained in step A1 to confirm whether or not there is a traffic lane at a predetermined portion of the image, specifically in this case, at the center position of the image in which the reference position K is set (at A8). When the traffic lane does not exist at the reference position K (i.e., “NO” at A8), the control unit 12 proceeds to step A6.

Further, when the traffic lane exists at the reference position K (i.e., “YES” at A8), the control unit 12 transmits the output unable information to the center server 20 (at A9). The output unable information is information indicating that the traffic lane position information P cannot be output or that it is preferable not to output the traffic lane position information P.

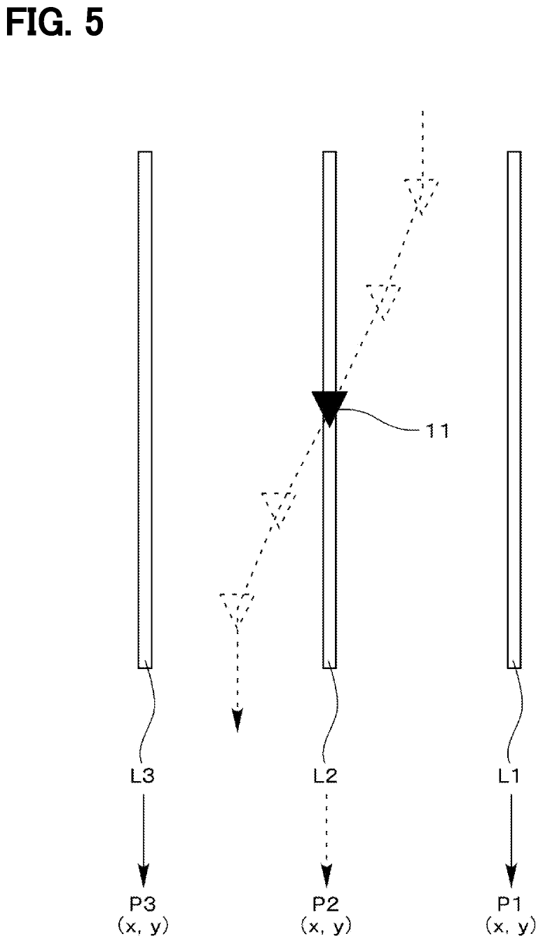

When the traffic lane exists in the center of the image in which the reference position K is set, there is a high possibility that the vehicle 11 straddles the traveling lane L2 due to, for example, changing lanes, as illustrated in FIG. 5. In such a case, there is a possibility that only the traffic lane position information P1 and P3 of the left and right driving lanes L1 and L3 except for the driving lane L2 may be output with reference to the reference position K overlapping the driving lane L2, that is, a possibility that the traffic lane position information P2 of the driving lane L2 is not output, and it may be difficult to accurately output the traffic lane position information P1, P2, P3 for all of the plurality of driving lanes L1, L2, L3.

More specifically, according to the traffic lane position information output device 10 according to the present embodiment, the control unit 12 scans the image from the center of the image in which the reference position K is set toward the left and right ends. Then, in the process of this scanning, the control unit 12 determines a point where the pixel value changes from a low pixel value, that is, a portion corresponding to asphalt other than the traffic lane mark of the road to a high pixel value, that is, a portion corresponding to the traffic lane mark, the edge of the traffic lane in the width direction thereof.

Therefore, the reference position K of the image, in this case, when there is a traffic lane in the center of the image, the traffic lane overlaps the reference position K, and the image is scanned from this reference position K toward the left and right ends. Even so, in the central traffic lane, even if there is a point where the pixel value changes from a high state to a low state, there is no point where the pixel value changes from a low state to a high state. Therefore, the control unit 12 cannot determine the widthwise end of the central traffic lane of this image, and therefore cannot recognize the existence of this traffic lane. That is, in the example shown in FIG. 5, the traveling lane L2 existing in the center of the image cannot be recognized or the recognition is difficult. Then, the traffic lane position information P2 cannot be accurately output for the traveling lane L2, or it becomes difficult.

Therefore, in the situation where the output traffic lane position information P may be inaccurate, that is, in the situation where the reference position K or the peripheral area around the reference position K overlaps the traffic lane, the control unit 12 does not output the traffic lane position information P, and instead, the unit 12 outputs the output unable information indicating that the traffic lane position information P cannot be output. In addition, this output unable information may include the reason why the traffic lane position information P cannot be output, and in this case, it may include the output unable reason information indicating a specific reason such that the reference position K or the peripheral area around the reference position k overlaps the traffic lane.

Further, as illustrated in FIG. 4, when the “traffic lane” is not extracted from the image (i.e., “NO” at A5), the control unit 12 executes the situation determination process based on the image analysis information (at A10) and the situation determination process based on the vehicle information (at A11). The execution order of the situation determination process (at A10) based on the image analysis information and the situation determination process (at A11) based on the vehicle information may be changed as appropriate, or both processes may be executed at the same time.

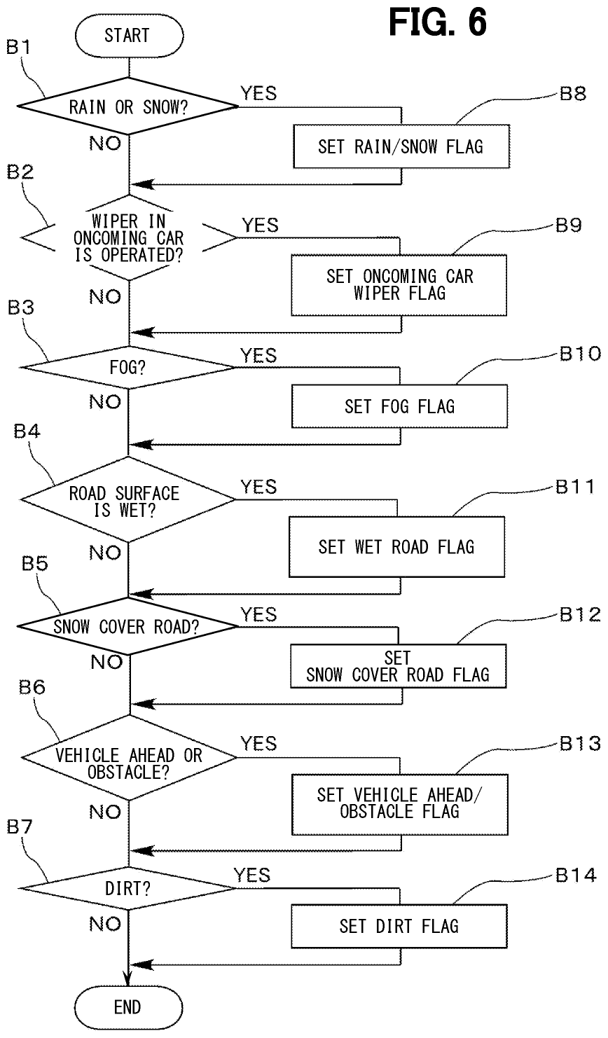

As illustrated in FIG. 6, in the situation determination process based on the image analysis information, the control unit 12 performs a well-known image analysis process on the image obtained in step A1 to determine whether or not the image shows rain or snow (at B1), whether the wiper of the oncoming vehicle shown in the image is operating (at B2), whether the image shows fog (at B3), whether the road shown in the image is wet (at B4), whether the road shown in the image is covered with snow (at B5), whether there are leading vehicles ahead the vehicle or obstacles in the image (at B6), and whether the image shows the dirt attached to the camera lens (at B7). The determination processes of steps B1 to B7 can be realized by applying a well-known image analysis process. Further, when a moving image is obtained by the imaging unit 13, a more accurate determination can be made by analyzing the moving image.

When the control unit 12 determines that rain or snow is reflected in the image (i.e., “YES” at B1), the control unit 12 sets the rain/snow flag (at B8). Further, when the control unit 12 determines that the wiper of the oncoming vehicle shown in the image is rotating (i.e., “YES” at B2), the control unit 12 sets the oncoming vehicle wiper flag (at B9). Further, when the control unit 12 determines that fog is reflected in the image (i.e., “YES” at B3), the control unit 12 sets the fog flag (at B10). Further, when the control unit 12 determines that the road shown in the image is wet (i.e., “YES” at B4), the control unit 12 sets the road wet flag (at B11). Further, when the control unit 12 determines that snow cover is observed on the road shown in the image (i.e., “YES” at B5), the control unit 12 sets the road snow cover flag (at B12). Further, when the control unit 12 determines that the preceding vehicle or an obstacle is reflected in the image (i.e., “YES” at B6), the control unit 12 sets the preceding vehicle/obstacle flag (at B13). Further, when the control unit 12 determines that the dirt adhering to the lens of the camera is reflected in the image (i.e., “YES” at B7), the control unit 12 sets the dirt flag (at B14).

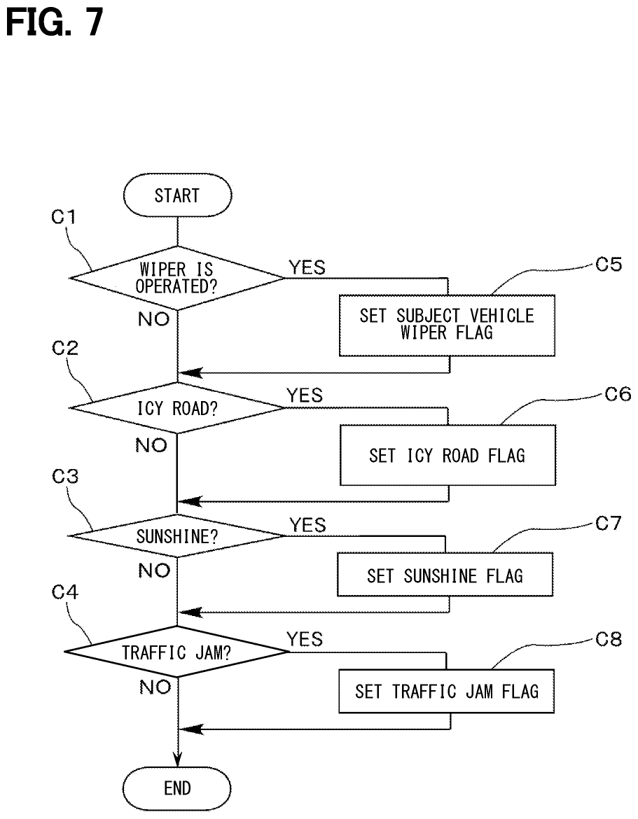

Further, as illustrated in FIG. 7, in the situation determination process based on the vehicle information, the control unit 12 determines whether or not the wiper of the vehicle 11 is operating (at C1), whether the road on which the vehicle 11 is traveling freezes (at C2), whether or not the road on which the vehicle 11 is traveling is exposed to sunlight (at C3), and whether or not the road on which the vehicle 11 is traveling is congested (at C4). The determination whether or not the wiper of the vehicle 11 is operating can be confirmed based on, for example, the operating status of the actuator that drives the wiper of the vehicle 11. The determination whether or not the road on which the vehicle 11 is traveling is frozen can be confirmed based on, for example, the operating status of the driving control system such as the antilock braking system (ABS), the vehicle safety control system (VSC), etc. The determination whether or not the road on which the vehicle 11 is traveling is irradiated with sunlight can be confirmed, for example, based on the detection status of a solar radiation sensor (not shown) provided in the vehicle 11. The determination whether or not traffic congestion occurs on the road on which the vehicle 11 is traveling can be confirmed, for example, based on the detection status of the vehicle speed sensor provided in the vehicle 11.

When the control unit 12 determines that the wiper of the vehicle 11 is operating (i.e., “YES” at C1), the control unit 12 sets the own vehicle wiper flag (at C5). Further, when the control unit 12 determines that the road on which the vehicle 11 is traveling is frozen (i.e., “YES” at C2), the control unit 12 sets the road freeze flag (at C6). Further, when the control unit 12 determines that the road on which the vehicle 11 is traveling is irradiated with sunlight (i.e., “YES” at C3), the control unit 12 sets the solar radiation flag (at C7). Further, when the control unit 12 determines that the traffic jam is occurring on the road on which the vehicle 11 is traveling (i.e., “YES” at C4), the control unit 12 sets the traffic jam flag (at C8).

As illustrated in FIG. 4, when the control unit 12 completes the situation determination process (at A10) based on the image analysis information and the situation determination process (at A11) based on the vehicle information, the control unit 12 transmits the extraction unable information to the center server 20 (at A12). The extraction unable information is information indicating that the traffic lane cannot be extracted or it is difficult to extract the traffic lane from the image data obtained by the imaging unit 13.

When an affirmative judgment is made in at least one of a plurality of judgment items (steps B1 to B7) in the situation determination process (at A10) based on the image analysis information, and/or when an affirmative judgment is made in at least one of a plurality of judgment items (steps C1 to C4) in the situation determination process (at A11) based on the vehicle information, it is highly likely that it will be difficult to extract a traffic lane from the image data obtained by the imaging unit 13. Therefore, in such a situation where it is difficult to extract a traffic lane from the image, the control unit 12 does not output the traffic lane position information P, and instead, the unit 12 transmits the extraction unable information indicating that the traffic lane cannot be extracted. The extraction unable information may include the extraction unable reason information indicating a specific reason such as the reason why the traffic lane cannot be extracted from the image, for example, the reason that rain or snow is reflected in the image, or the wiper of the vehicle 11 is operating. The reason why the extraction is not possible may be specified based on the setting status of the plurality of types of flags described above.

According to the traffic lane position information output device 10 according to the present embodiment, the traffic lane position information P is output only in a specific case when the traffic lane is accurately shown in the image captured by the imaging unit 13, that is, for example, when the traffic lane does not exist in the center of the image captured by the imaging unit 13, or when the lane keeping function for driving the vehicle 11 along the traveling lane is turned off. A more accurate lane map can be generated based on the traffic lane position information P output in a predetermined case where the traffic lane appears accurately in the image captured by the imaging unit 13. That is, according to the traffic lane position information output device 10 according to the present embodiment, it is possible to output traffic lane position information P for generating a more accurate lane map.

Further, according to the traffic lane position information output device 10, when the traffic lane cannot be extracted from the image captured by the imaging unit 13, the extraction unable information indicating that the traffic lane cannot be extracted is output. According to this configuration, when the traffic lane cannot be extracted from the image captured by the imaging unit 13, that is, when the traffic lane cannot be extracted for some reason even though the traffic lane exists in the image, the reason is positively shown. Further, by positively showing the reason why the lane cannot be extracted from the image, it is possible to clearly distinguish the case where the lane is not extracted from the case where the lane does not exist in the image in the first place.

The present disclosure is not limited to the above-described embodiment, and various modifications and extensions can be made without departing from the gist thereof. For example, in the present disclosure, not only when the vehicle 11 changes lanes, but also in a situation where the vehicle 11 crosses the lane, for example, in order to avoid a parked vehicle on the roadside and to avoid an obstacle in front of the traveling direction, in order to avoid the construction site, it can be applied in situations where the vehicle crosses lanes.

Further, the mounting position of the imaging unit 13 on the vehicle 11 may be the central portion in the width direction of the vehicle 11 or may be another position thereof. Further, the set position of the reference position K may be appropriately adjusted according to the mounting position of the imaging unit 13 in the vehicle 11.

The traffic lane position information output device 10 may include a component corresponding to the map generation unit 21 of the center server 20. That is, the traffic lane position information output device 10 may be used alone to perform a series of controls including extraction of a traffic lane from an image, identification of the extracted traffic lane position, and generation of a traffic lane map based on the specified traffic lane position.

Although the present disclosure has been described in accordance with the examples, it is understood that the present disclosure is not limited to such examples or structures. The present disclosure also includes various modifications and modifications within an equivalent range. In addition, various combinations and forms, and further, other combinations and forms including only one element, or more or less than these elements are also within the sprit and the scope of the present disclosure.

The control unit and the method thereof described in the present disclosure are realized by a dedicated computer provided by configuring a processor and a memory programmed to execute one or more functions embodied by a computer program. Alternatively, the control unit and the method described in the present disclosure may be realized by a dedicated computer provided by configuring a processor with one or more dedicated hardware logic circuits. Alternatively, the control unit and the method thereof described in the present disclosure are based on a combination of a processor and a memory programmed to execute one or more functions and a processor configured by one or more hardware logic circuits. It may be realized by one or more configured dedicated computers. The computer programs may be stored, as instructions to be executed by a computer, in a tangible non-transitory computer-readable storage medium.

It is noted that a flowchart or the processing of the flowchart in the present application includes sections (also referred to as steps), each of which is represented, for instance, as A1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A traffic lane position information output device comprising:
an imaging unit that images a periphery of a vehicle;
a traffic lane extraction unit that extracts a traffic lane from an image captured by the imaging unit; and
a traffic lane position information output unit that outputs traffic lane position information indicating a position of the traffic lane extracted by the traffic lane extraction unit, wherein:
the traffic lane position information output unit outputs the traffic lane position information in a predetermined case where the traffic lane appears accurately in the image captured by the imaging unit.

2. The traffic lane position information output device according to claim 1, wherein:
the predetermined case includes a case where the traffic lane is not disposed in a center of the image captured by the imaging unit.

3. The traffic lane position information output device according to claim 1, wherein:
the predetermined case includes a case where a lane keeping function for controlling the vehicle to travel along a traveling lane is turned off.

4. The traffic lane position information output device according to claim 1, wherein:
the traffic lane extraction unit outputs extraction unable information indicating that the traffic lane cannot be extracted when the traffic lane cannot be extracted from the image captured by the imaging unit.

5. A traffic lane position information output device comprising:
one or more processors; and
a memory coupled to the one or more processors and storing program instructions that when executed by the one or more processors cause the one or more processors to at least:
image a periphery of a vehicle;
extract a traffic lane from an image captured by the imaging of the periphery; and
output traffic lane position information indicating a position of the traffic lane extracted by the extracting of the traffic lane, wherein:
the outputting of the traffic lane position information is executed in a predetermined case where the traffic lane appears accurately in the image captured by the imaging of the periphery.
